(19) United States
(12) Patent Application Publication
(10) Pub. No.: US 2020/0099218 A1
(43) Pub. Date: Mar. 26, 2020

(54) INTELLIGENT THREE-PHASE POWER SWITCH CONTROLLER

(71) Applicant: Charles J. Adams, Midland, TX (US)

(72) Inventor: Charles J. Adams, Midland, TX (US)

(21) Appl. No.: 16/574,723

(22) Filed: Sep. 18, 2019

Related U.S. Application Data
(60) Provisional application No. 62/736,310, filed on Sep. 25, 2018.

(51) Int. Cl. H02H 7/26; G05B 19/045; H02H 1/04

(52) U.S. Cl. CPC H02H 7/26; G05B 2219/21154; H02H 1/043; G05B 19/045

(57) ABSTRACT

In some embodiments, a controller of an intelligent switch in a three-phase power distribution network is configured to serve as a sectionalizer. The controller preferably includes voltage restraint logic and count restraint logic to prevent opening of the switch in response to a detected fault unless the voltage and current drop below minimum threshold values. The controller preferably additionally includes inrush restraint logic that prevents detection of a fault in response to an inrush current spike that may occur, for example, on startup of an AC motor or when energizing a transformer. The controller preferably further includes close-on-fault detection logic that bypasses counting of fault/line clear events by the controller if the switch is closed on a fault.

### BACKGROUND OF THE INVENTION

The present invention relates to electrical power distribution systems, and more particularly, to intelligent power switch controllers suitable for three-phase high voltage power distribution systems.

In the prior art, high voltage power distribution systems have conventionally employed protective devices such as reclosing breakers (reclosers), hydraulic-mechanical sectionalizers (sectionalizers), and per-phase fuses to protect the power distribution system against damage in the presence of catastrophic events, such as phase faults and ground faults. Reclosing breakers cycle repeatedly for long duration faults, eventually locking out the entire downstream power distribution system or portions of the system having sectionalizers in order to isolate faults. Fuses similarly protect the power distribution system by melting in the presence of overcurrent events of sufficient duration. The protective actions of reclosing breakers and fuses can impact a significant number of customers and result in extensive power outages. Power interruptions and downtime negatively impact reliability metrics of the power distribution system, such as the System Average Interruption Frequency Index (SAIFI), System Average Interruption Duration Index (SAIDI), Customer Average Interruption Frequency Index (CAIFI), and Customer Average Interruption Duration Index (CAIDI).

### BRIEF SUMMARY

The present disclosure appreciates that with the obsolescence of three-phase hydraulic-mechanical technology it would be desirable to supplement the protection to a power distribution system provided by conventional protective devices (e.g., reclosing breakers, hydraulic-mechanical sectionalizers, and fuses) with an intelligent switch configured as a three-phase sectionalizer.

In some embodiments, an intelligent switch configured as a sectionalizer is used in coordination with an upstream and/or downstream protective device such as reclosing breaker to automatically isolate a faulted section of a power distribution system.

In some embodiments, a controller of an intelligent switch detects an overcurrent event that is cleared by a downstream protective device without a corresponding voltage change on an upstream power distribution circuit. In response to the detection, the controller employs voltage restraint and does not open the switch, but instead permits a coordinating downstream protective device to cycle to clear the overcurrent event.

In some embodiments, a controller of an intelligent switch senses that a current on one or more phases of a power distribution circuit has exceeded a threshold current and initiates counting of a number of times that an upstream protective device de-energizes the circuit. The intelligent controller discriminates between normal inrush current while energizing and load-starting versus fault current. In response to the count satisfying a predetermined threshold count, and while the circuit is de-energized, the controller opens the switch, which isolates a section of the power distribution system without the upstream protective device locking out the entire circuit.

In some embodiments, a controller of an intelligent switch analyzes the power system and, if a fault is detected upon closing the switch, then normal counting of a number of times the circuit is de-energized by an upstream device is bypassed. The controller opens the switch immediately when the circuit becomes de-energized. The intelligent controller thus detects close-on-fault conditions, overrides the normal counter sequence, and protects the high voltage system and operations personnel from damage and danger caused by repeated cycling of a faulted circuit.

### BRIEF DESCRIPTION OF THE SEVERAL VIEWS OF THE DRAWINGS

FIG. 1 is a high level block diagram of a power distribution system including an intelligent power switch controller in accordance with one embodiment;

FIG. 2 is a more detailed block diagram of a load break switch (LBS) and associated intelligent power switch controller in accordance with one embodiment;

FIG. 3 is a more detailed block diagram of control logic circuitry employed in a controller in accordance with one embodiment;

FIGS. 4A-4B together form a high level logical flowchart of an exemplary process by which an intelligent power switch controller trips a switch in accordance with one embodiment;

FIG. 5 is a high level logical flowchart of an exemplary process by which an intelligent power switch controller opens a switch in accordance with one embodiment;

FIG. 6 depicts the implementation of an LBS in a utility environment in accordance with one embodiment; and

FIG. 7 illustrates the implementation of an LBS in an industrial environment in accordance with one embodiment.

### DETAILED DESCRIPTION

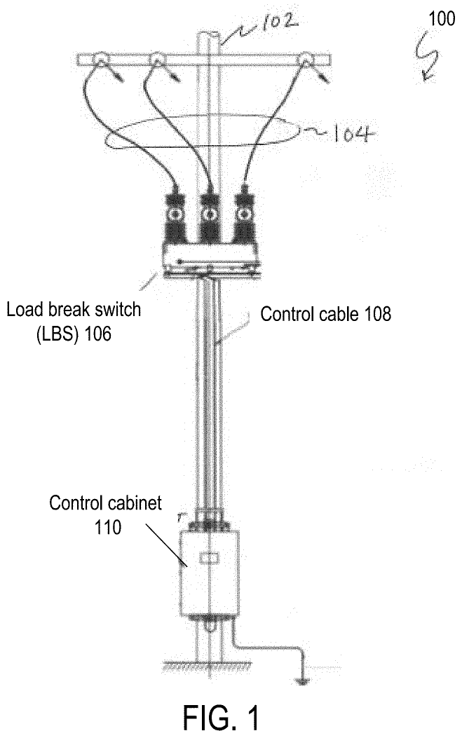

With reference now to the figures, and in particular with reference to FIG. 1, there is illustrated a high level block diagram of a three-phase electrical power distribution system 100 including an intelligent power switch controller in accordance with one embodiment. As shown, electrical power distribution system 100 includes a power pole 102 supporting power lines 104 providing high-voltage three-phase electrical power. For example, in this embodiment, power lines 104 may supply 12.47 kV, 14.4 kV, 21.6 kV, 24.9 kV, or any nominal distribution voltage below 25.8 kV power.

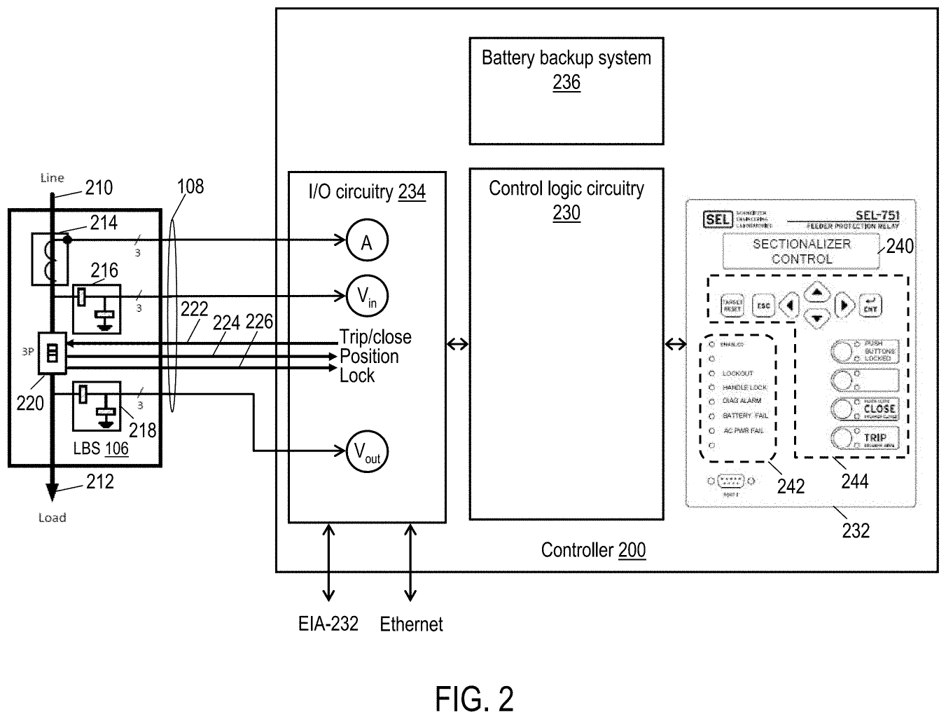

Power lines 104 are coupled to a load break switch (LBS) 106, which in some embodiments comprises a vacuum interrupter encapsulated in a molded hydrophobic cycloaliphatic epoxy bushing. In some embodiments, LBS 106 is configured to be compliant with International Electrotechnical Commission (IEC) 6227-103. One supplier of such an LBS is Entec Electric and Electronic Co., Ltd. As further shown in FIG. 1, LBS 106 is electronically controlled by an intelligent power switch controller 200 (see, e.g., FIG. 2) disposed in an associated pole-mounted control cabinet 110. Intelligent power switch controller 200 communicates with LBS 106 via a control cable 108.

Referring now to FIG. 2, there is depicted a more detailed block diagram of a load break switch (LB S) 106 and associated intelligent power switch controller 200 in accordance with one embodiment. In the illustrated embodiment, LBS 106 includes a three-phase line input 210 configured to be coupled to high voltage three-phase power lines, as well as a three-phase load output 212 suitable for supplying three-phase power to a section of a power distribution system. On its input side, LBS 106 includes an input current sense circuit 214 (e.g., an inductive current sense circuit) and an input voltage sense circuit 216 (e.g., a resistive voltage divider) that respectively provide to controller 200 an indication of the current and voltage on each of the three phases of line input 210. LBS 106 similarly includes, on its output side, an output voltage sense circuit 218 (e.g., another resistive voltage divider) that provides to controller 200 an indication of the voltage on each of the three phases of load output 212.

Interposed between the input and output sides of LBS 106 is a three pole switch 220. Three pole switch 220 has a tripped (open) state in which power conduction between input 210 and output 212 is interrupted for all three phases and a closed state in which power is conducted between input 210 and output 212 on all three phases. Three pole switch 220 transitions between its tripped and closed states in response to a trip/close signal 222 supplied by controller 200. Three pole switch 220 additionally provides controller 200 with a switch position signal 224 indicating whether three pole switch 220 is in the tripped or closed state and a lock signal 226 indicating whether three pole switch 220 is locked in the tripped state (e.g., by actuation of a mechanical safety lock).

Controller 200 receives the indications of the input currents and voltages, output voltages, and signals 224-226 via control cable 108. Based on these signals and its internal logic, controller 200 selectively and intelligently asserts trip/close signal 222 to trip and to close switch 220 in order to protect power distribution systems and the electrically powered equipment coupled thereto.

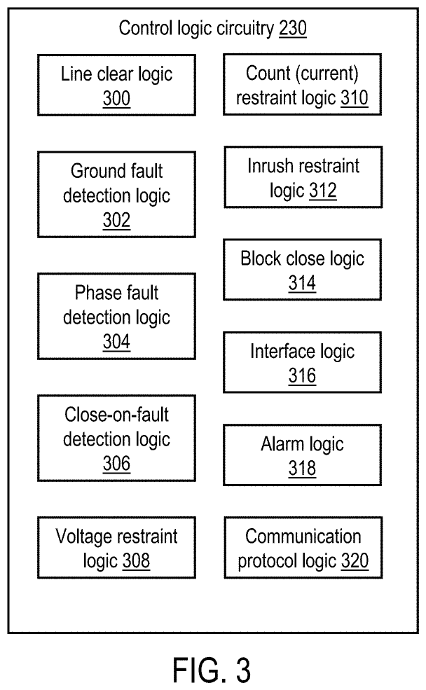

As further shown in FIG. 2, in the depicted embodiment, controller 200 includes at least control logic circuitry 230 (depicted in greater detail in FIG. 3), a human interface 232, input/output (I/O) circuitry 234, and battery backup system 236. In various embodiments, control logic circuitry 230 can be implemented entirely in hardware (e.g., discrete components or integrated circuitry) or in integrated circuit hardware configured by software and/or firmware. In either case, control logic circuitry 230 is configured to intelligently implement radial sectionalizing in a power distribution system utilizing LBS 106. Thus, as described further herein, control logic circuitry 230 provides a number of available functions, including three-phase voltage restraint, close-on-fault, inrush restraint, current restraint, phase fault detection, ground fault detection, communication via standard communication protocols (e.g., Supervisory Control And Data Acquisition (SCADA)), safety interlock, and alarms.

In the illustrated embodiment, human interface 232 includes a display 240 through which control logic circuitry 230 can present status information, configuration information, instructions and the like to a human operator. In addition, human interface 232 includes a bank of status lights 242 providing a visual indication of the status of LBS 106 and/or controller 200. Human interface 232 also includes a number of buttons 244 that a human operator can utilize to enter configuration information into controller 200, open and close LBS 106, request display of status information in display 240, etc.

I/O circuitry 234 is configured to communicate with LBS 106 via control cable 108 as described above. In addition, I/O circuitry 234 preferably supports communication between controller 200 and other devices utilizing wired and/or wireless communication protocols (e.g., EIA-232 and/or Ethernet).

Battery backup system 236 provides battery backup power for controller 106. In this manner, controller 106 is able to operate when three-phase line input 210 and/or a local controller power system (not illustrated) is/are without power. In one exemplary embodiment, battery backup system includes a 24 V battery capable of providing a 10-hour power supply to controller 106, as well as a battery charging circuit.

In one exemplary embodiment, controller 200 can be implemented with a custom-programmed off-the-shelf device, such as the SEL-751 available from Schweitzer Engineering Laboratories (SEL).

With reference now to FIG. 3, there is illustrated a more detailed block diagram of the control logic circuitry 230 of controller 200 in accordance with at least one embodiment. In the illustrated example, LBS 106 is not rated to function as a reclosing breaker and thus does not open on a faulting power line. Consequently, control logic circuitry 230 includes line clear logic 300, which detects a line clear condition prior to permitting LBS 106 to open. For example, line clear logic 300 may detect a line clear condition if I/O circuitry 234 senses no current and no voltage on input 210 for a predetermined time period (e.g., 1 s).

Control logic circuitry 230 also includes ground fault detection logic 302 and phase fault detection logic 304 for detecting faults to ground and between phases. These faults can be reported by controller 200, for example, via display 240, status lights 242, and/or remote communication.

In order to reduce or avoid damage to electrical equipment or the power distribution system, control logic circuitry 230 is preferably equipped with close-on-fault detection logic 306. Close-on-fault detection logic 306 detects closure of LBS 106 on a faulting circuit, and in response to this detection, opens LBS 106 on a line clear condition without any counting.

Control logic circuitry 230 further includes voltage restraint logic 308, count restraint logic 310, and inrush restraint logic 312. As discussed further herein, voltage restraint logic 308 inhibits line clear logic 300 from detecting a line clear condition and from opening LBS 106 in response to a fault unless the sensed input voltage is less than a threshold voltage. Count restraint logic 310 additionally inhibits line clear logic 300 from detecting a line clear condition and from opening LBS 106 unless the sensed input current is less than a threshold current. Inrush restraint logic 312 further inhibits detection of a fault under conditions having the signature of inrush current, which can occur, for example, at motor startup or when energizing a transformer.

Control logic circuitry 230 further includes block close logic 314, which blocks closure of LBS 106 under predetermined conditions. For example, in a preferred embodiment, block close logic 314 prevents closure of LBS 106 if signal 224 indicates that a mechanical safety lock is engaged, regardless of any close command entered either remotely or via human interface 232.

Control logic circuitry 230 additionally includes interface logic 316, alarm logic 318, and communication protocol logic 320. Interface logic 316 provides the logic to receive inputs from, and provide outputs to, human interface 232. Alarm logic 318 triggers communication of alarms to human interface 232 and/or remote network-connected devices in response to alarm conditions, such as engagement of battery backup system 236, the detection of various fault conditions, etc. Communication protocol logic 316 supports communication of command, alarm, and status information between controller 200 and remote network-connected devices. As noted above, this communication, which may be over wired and/or wireless communication networks, may employ communication protocols such as EIA-232, Ethernet, SCADA, etc.

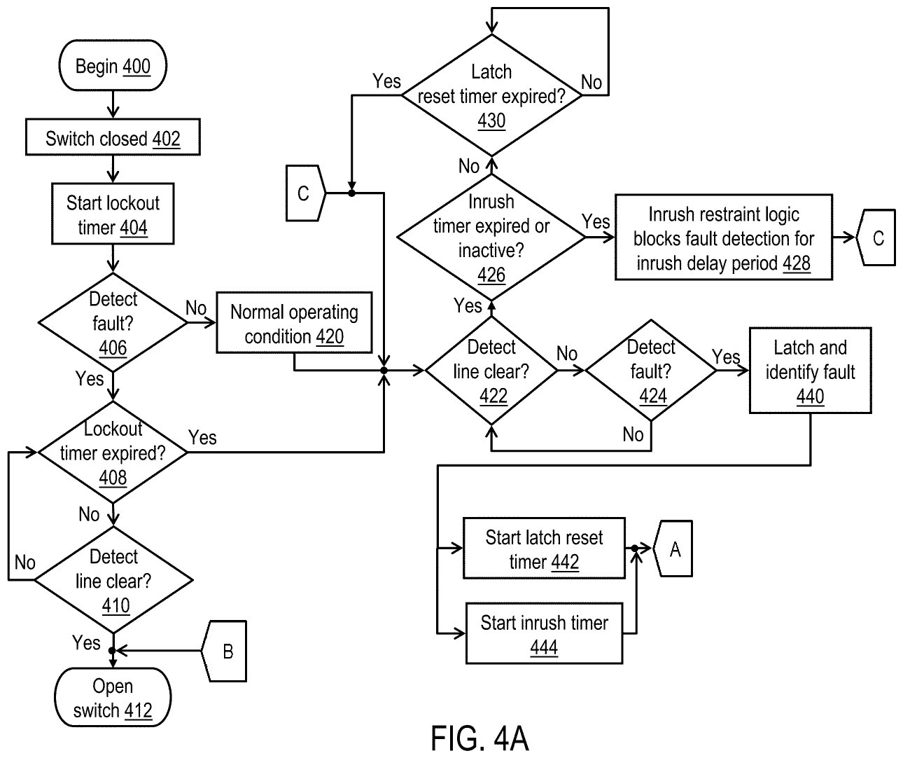

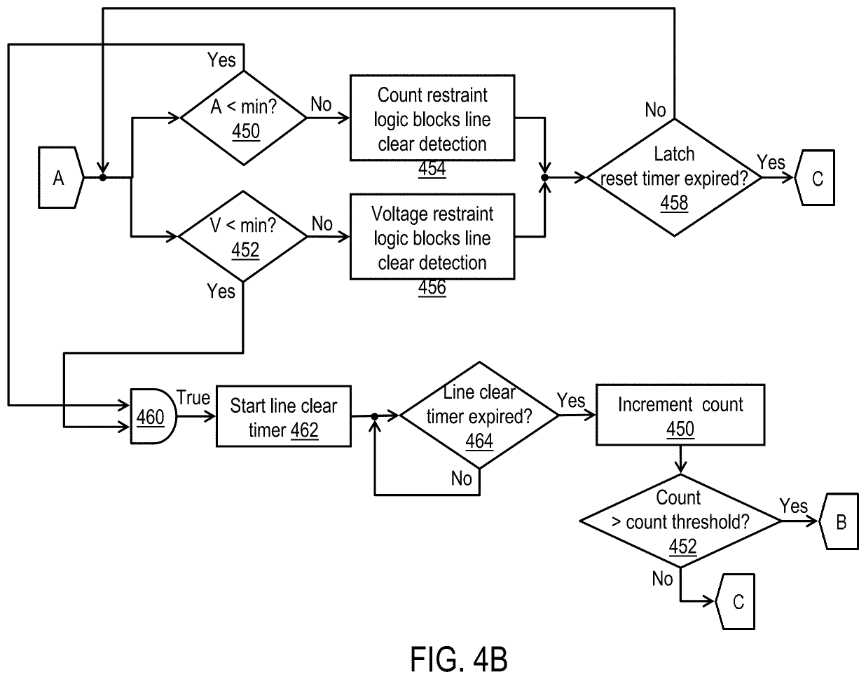

Referring now to FIGS. 4A-4B, there is depicted a high level logical flowchart of an exemplary process by which an intelligent power switch controller, such as controller 200, trips a switch in accordance with one embodiment. As a logical flowchart, steps are presented in logical rather than strictly chronological order. Consequently, those skilled in the art will appreciate that in various embodiments at least some of the illustrated steps can be performed in an alternative order or concurrently.

The process begins at block 400 of FIG. 4A and then proceeds to block 402, which illustrates controller 200 asserting trip/close signal 222 to close LBS 106. In addition, at block 404, control logic circuitry 230 starts a lockout timer that defines a close-on-fault monitoring period in which control logic circuitry 230 monitors for a close-on-fault condition. This monitoring period may be, for example, about 10 s. As indicated at block 406, if no fault is detected by ground fault detection logic 304 or phase fault detection logic 306 within the close-on-fault monitoring period, the process proceeds to block 420 and following blocks, which are described below. If, on the other hand, a ground fault is detected by ground fault detection logic 304 or a phase fault is detected by phase fault detection logic 306 within the close-on-fault monitoring window, the process proceeds to blocks 408-410.

At blocks 408-410, control logic circuitry 230 determines whether or not a line clear condition is detected by line clear logic 300 within the close-on-fault monitoring period. As indicated above, line clear logic 300 preferably only detects a line clear condition if the input voltage and input current on all phases of line input 210 are below predetermined thresholds for at least a predetermined line clear interval (e.g., about 1 s). In response to detection of the line clear condition within the close-on-fault monitoring period, control logic circuitry 230 causes I/O circuitry 234 to assert trip/close signal 222 to trip (open) LBS 106 (block 412). It should be noted that, in this case, controller 200 opens LBS 106 without any counting of fault detections or line clear conditions. As a result, damage to electrical equipment and/or the power distribution system can be reduced or avoided. If, however, no line clear condition is detected within the close-on-fault monitoring period, controller 200 refrains from operating LBS 106 with an active fault (as it is not rated for such operation), and the process passes to block 422, which is described below.

Referring now to block 420, if no close-on-fault condition was detected following closure of LBS 106, controller 200 assumes a normal operating condition. At blocks 422 and 424, controller 200 monitors for the first to occur of a line clear condition (block 422) and a fault (block 424). In response to detection of a line clear condition, the process proceeds from block 422 to block 426, which illustrates a determination of whether or not an inrush timer (which is started at block 444 in response to detection of a fault) has expired or is inactive. If the process reaches block 426 without a fault first being detected and latched, then the inrush timer will be inactive. If the inrush timer is expired or inactive, inrush restraint logic 312 blocks fault detection by fault detection logic 304, 306 for an inrush delay period. In this manner, a high current surge associated with the startup of AC motors or energizing a transformer is not incorrectly detected as a fault condition (which could potentially cause LBS 106 to be tripped). Thereafter, the process returns through page connector C to blocks 422-424.

Returning to block 426, if controller 200 determines that the inrush timer is active and has not expired, then a line clear condition has been detected following a fault. This sequence can occur, for example, if the cycling of an upstream reclosing breaker clears the detected fault. The process accordingly proceeds from block 426 to block 430, which illustrates controller 200 waiting for expiration of latch reset timer (which is started at block 442 following detection of a fault). In response to expiration of the latch reset time, the process returns to blocks 422-424.

Referring now to block 424, in response to detection of a fault by fault detection logic 304 or 306, controller 200 latches and identifies the type of fault (e.g., ground fault or phase fault). In response to detection of the fault, controller 200 starts the latch reset timer (block 442) and the inrush timer (block 444). The latch reset timer, which can have a duration of about 15 s, defines a time window after which the latched fault will be discarded if a selected number of line clear conditions is not satisfied within the time window. In at least some embodiments, the inrush timer, which defines the duration of the inrush delay period, has a longer duration, for example, of about 45 s. Following blocks 442-444, the process passes through page connector A to FIG. 4B.

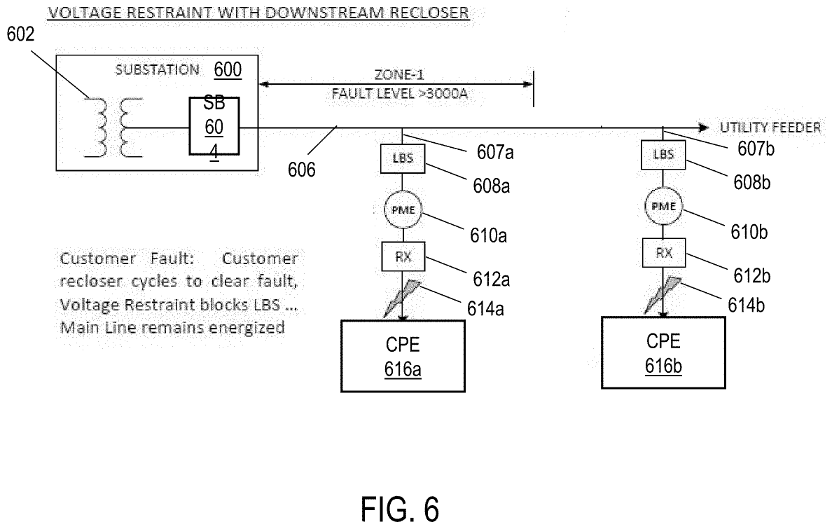

With reference now to FIG. 4B, the process begins at page connector A and then proceeds to blocks 450-452, which respectively illustrate controller 200 determining whether or not the current on all three phases is less than a minimum threshold current (e.g., about 5 A) and whether or not the voltage on all three phases is less than a minimum threshold voltage (e.g. about 500 V). If a determination is made at block 450 that the input current on all 3 phases of line input 210 is not less than the minimum threshold current, count restraint logic 310 blocks sensing of a line clear condition by line clear logic 300 (block 454). If a determination is made at block 452 that the input voltage on all 3 phases of line input 210 is not less than the minimum threshold voltage, voltage restraint logic 308 blocks sensing of a line clear condition by line clear logic 300 (block 456). This condition may occur, for example, if a downstream fault is sensed, but is cleared by a downstream reclosing breaker, as described below with reference to FIG. 6. Following a negative determination at either or both of blocks 450, 452, controller 200 determines whether or not the latch reset timer has expired (block 458). If not, the process returns to blocks 450-452, representing controller 200 continuing to determine whether or not the input currents and voltages are less than their respective minimum thresholds. If, however, controller 200 determines at block 458 that the latch reset timer has expired, meaning that the fault detected at blocks 424, 440 was not followed by a line clear condition within the duration of the latch reset timer, the process returns through page connector C to blocks 422-424, which have been described.

As indicated by AND gate 460, if controller 200 detects that both of the low current and low voltage conditions indicated at blocks 450-452 are satisfied, controller 200 determines whether or not the low current and low voltage conditions remain true for a predetermined line clear duration determined by a line clear timer (blocks 462-464). In an exemplary embodiment, the line clear duration may be, for example, 1 s. If controller determines at blocks 462-464 that the low current and low voltage conditions remain true for the predetermined line clear duration, controller 200 increments a line clear count (block 450). As depicted at block 452, if the line clear count satisfies a count threshold (e.g., 2, 3, or 4), the process passes through page connector B to block 412 of FIG. 4A, which represents controller 200 asserting trip/close signal 222 to cause LBS 106 to open. If, on the other hand, controller 200 determines at block 452 that the line clear count does not satisfy the count threshold, the process returns through page connector C to blocks 422-424 of FIG. 4A. In this manner, after controller 200 has entered its normal operating mode, controller 200 only opens LBS 106 in response to a detected fault if the number of detected fault/line clear conditions satisfies a count threshold, which can be programmable. As a result, controller 200 can be configured as desired to coordinate its operation with other protective devices, such as upstream and downstream reclosing breakers, that are present in the power distribution system.

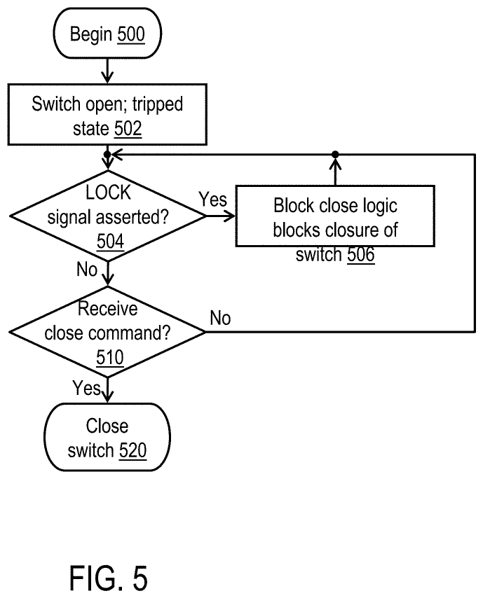

With reference now to FIG. 5, there is illustrated a high level logical flowchart of an exemplary process by which an intelligent power switch controller opens a switch in accordance with one embodiment. The process of FIG. 5 begins at block 500 and then proceeds to block 502, which illustrates LBS 106 beginning in a tripped (open) state. As indicated at blocks 504-506, if LOCK signal 226 is asserted (e.g., due to a mechanical safety lock being engaged on LBS 106), block close logic 314 blocks assertion of trip/close signal 222, preventing closure of LBS 106. If controller 200 determines at block 504 that LOCK signal 226 is not asserted, controller 200 additionally determines at block 510 whether or not a close command has been received, for example, via human interface 232 or from a remote network-connected device. If no close command has been received, the process returns to block 504, which has been described. If, however, controller 200 receives a close command at block 510, controller 200 asserts trip/close signal 222, causing LBS 106 to close (block 520).

Referring now to FIG. 6, there is depicted an implementation of an LBS in a utility environment in accordance with one embodiment. The depicted utility environment includes a utility substation 600, which includes a power transformer 602 that converts input three-phase power to a target output voltage. Equipment within utility substation 600, including power transformer 602, is protected from downstream faults by a station breaker (SB) 604. Substation 600 provides high-voltage three-phase power to downstream customers via power lines 606, which are coupled to multiple utility feeder branches 607a, 607b providing three-phase power to customer premises equipment (CPE) 616, such as CEP 616a, 616b. As indicated, one or more of these utility feeder branches 607 (e.g., utility feeder branch 607a) may be within a Zone 1 in which the current of faults may be extremely large (e.g., greater than 3000 A and perhaps up to 6000 A), and one or more others of utility feeder branches 607 (e.g., utility feeder branch 607b) may be outside Zone 1. In a typical implementation, Zone 1 may extend a mile or more from utility substation 600.

In the depicted embodiment, utility feeder branches 607a, 607b are each coupled to a respective one of intelligent LBSs 608a, 608b as described above. In each utility feeder branch 607a, 607b, the primary metering equipment (PME) 610a, 610b of the utility and the customer's reclosing breaker 612a, 612b are downstream of the LBS 608. Each utility feeder branch 607a, 607b terminates at customer premises equipment (CPE) 616a, 616b, which may comprise, for example, three-phase motors or other electrical equipment.

In the described environment, a fault 614a or 614b may occur in CPE 616 and/or on the power lines between reclosing breaker 612 and CPE 616. In the illustrated configuration, the customer's reclosing breaker 612 cycles (opens and closes) in an attempt to clear the detected fault. However, because LBS 608 continues to sense voltage on line input 210 during the cycling of reclosing breaker 612, voltage restraint logic 308 prevents controller 200 from opening LBS 608. However, because the cycling of reclosing breaker 612 clears the fault, the fault does not cause station breaker 604 to open, leaving power lines 606 energized.

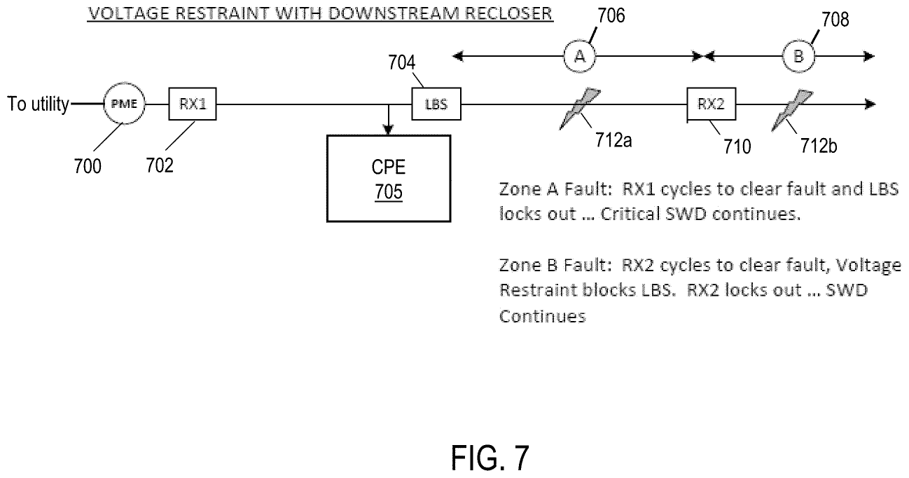

With reference now to FIG. 7, there is illustrated an implementation of an LBS in an industrial environment in accordance with one embodiment. The depicted industrial environment includes PME 700, which is coupled to the power utility's three-phase power distribution system and demarks the boundary of the customer premises. Downstream of PME 700 is a reclosing breaker 702 and an intelligent LBS 704 as described above. The power lines between reclosing breaker 702 and LBS 704 contain a tap supplying three-phase power to CPE 705, which can be, for example, critical facilities, such as a central pump station for salt water disposal (SWD). Downstream of LBS 704 is a feeder line including zone A 706 and zone B 708, which are coupled by an intermediate reclosing breaker 710.

In the described industrial environment, a fault 712a in zone A 706 or fault 712b in zone B 708 may occur. If a fault 712a occurs in zone A 706, upstream reclosing breaker 702 cycles (opens and closes) in an attempt to clear the detected fault. LBS 704 is configured with appropriate count thresholds to coordinate with reclosing breaker 702 so that controller 200 opens LBS 704 during the cycling of reclosing breaker 702 prior to reclosing breaker 702 ending its cycling and remaining a locked open state. As a result, LBS 704 isolates fault 712a and permits CPE 705 to continue to operate.

If, however, a fault 712b occurs in zone B 708, downstream reclosing breaker 710 cycles (opens and closes) in an attempt to clear the detected fault. Because LBS 704 continues to sense voltage on its line input 210 during the cycling of reclosing breaker 710, voltage restraint logic 308 prevents controller 200 from opening LBS 704. As fault 712b is cleared, power continues to be supplied to CPE 705, permitting it to continue to operate.

While various inventions have been particularly shown as described with reference to one or more preferred embodiments, it will be understood by those skilled in the art that various changes in form and detail may be made therein without departing from the spirit and scope of the invention. Reference made herein to an “embodiment” or “embodiments” do not all necessarily refer to one and the same embodiment, and those skilled in the art will appreciate that features of different embodiments can be combined and/or substituted in accordance with the disclosure provided herein. Further, as used herein, the term “about” indicates a value that is equal to the stated value ±20%.

The inventions disclosed herein may be realized as a system, a method, and/or a computer program product. A computer program product may include a storage device having computer-readable program code stored thereon for causing a processor (which may be part of control logic circuitry 230) to carry out aspects of the inventions. The storage device may be, for example, an electronic storage device, a magnetic storage device, an optical storage device, an electromagnetic storage device, a semiconductor storage device, or any suitable combination of the foregoing. Specific examples of the storage device include a portable computer diskette, hard disk, random access memory (RAM), static random access memory (SRAM), read-only memory (ROM), an erasable programmable memory (EPROM or Flash memory), compact disc (CD), digital versatile disk (DVD), and a memory stick. A storage device, as used herein, is specifically defined to include only statutory subject matter and to exclude non-statutory subject matter, such as signal media per se, transitory propagating signals per se, and energy per se.

What is claimed is:

1. A controller for an intelligent three-phase power switch, wherein the controller is configured to detect an overcurrent event that is cleared by a downstream protective device without a corresponding voltage change on an upstream portion of a power distribution circuit, and, responsive to detecting the overcurrent event, to employ voltage restraint and refrain from opening the intelligent three-phase power switch, such that a coordinating downstream protective device can clear the overcurrent event by cycling.

2. The controller of claim 1, wherein the controller is further configured to:
sense that a current on one or more phases of a downstream portion of the power distribution circuit has exceeded a threshold current and initiate counting of a number of times that an upstream protective device de-energizes the power distribution circuit;
responsive to the count satisfying a predetermined threshold count, and while the power distribution circuit is de-energized, open the intelligent three-phase power switch to isolate the downstream portion of the power distribution system without the upstream protective device locking out all of the power distribution circuit.

3. A power control system, comprising:
the controller of claim 1; and
the intelligent three-phase power switch.

4. A controller for an intelligent three-phase power switch, comprising:
control logic circuitry configured to:
sense that a current on one or more phases of a downstream portion of a power distribution circuit has exceeded a threshold current and initiate counting of a number of times that an upstream protective device de-energizes the power distribution circuit;
responsive to a count satisfying a predetermined threshold count, and while the power distribution circuit is de-energized, open the intelligent three-phase power switch to isolate the downstream portion of the power distribution system without the upstream protective device locking out all of the power distribution circuit.

5. The controller of claim 4, wherein the control logic circuitry is further configured to:
detect an overcurrent event that is cleared by a downstream protective device without a corresponding voltage change on an upstream portion of the power distribution circuit; and
responsive to detecting the overcurrent event, employ voltage restraint and refrain from opening the intelligent three-phase power switch, such that a coordinating downstream protective device can clear the overcurrent event by cycling.

6. A power control system, comprising:
the controller of claim 4; and
the intelligent three-phase power switch.

7. A method of controlling an intelligent three-phase power switch, the method comprising:
a controller of an intelligent three-phase power switch detecting an overcurrent event that is cleared by a downstream protective device without a corresponding voltage change on an upstream portion of a power distribution circuit, and
responsive to detecting the overcurrent event, the controller employing voltage restraint and refraining from opening the intelligent three-phase power switch, such that a coordinating downstream protective device can clear the overcurrent event by cycling.

8. The method of claim 7, and further comprising:
responsive to sensing that a current on one or more phases of a downstream portion of the power distribution circuit has exceeded a threshold current, the controller initiating counting of a number of times that an upstream protective device de-energizes the power distribution circuit;
responsive to a count satisfying a predetermined threshold count, and while the power distribution circuit is de-energized, the controller opening the intelligent three-phase power switch to isolate the downstream portion of the power distribution system without the upstream protective device locking out all of the power distribution circuit.

9. A method of controlling an intelligent three-phase power switch, the method comprising:
based on sensing that a current on one or more phases of a downstream portion of a power distribution circuit has exceeded a threshold current, a controller of the intelligent three-phase power switch initiating counting of a number of times that an upstream protective device de-energizes the power distribution circuit;
responsive to a count satisfying a predetermined threshold count and while the power distribution circuit is de-energized, the controller opening the intelligent three-phase power switch to isolate the downstream portion of the power distribution system without the upstream protective device locking out all of the power distribution circuit.

10. The method of claim 9, and further comprising:
based on detecting an overcurrent event that is cleared by a downstream protective device without a corresponding voltage change on an upstream portion of the power distribution circuit, the controller employing voltage restraint and refraining from opening the intelligent three-phase power switch, such that a coordinating downstream protective device can clear the overcurrent event by cycling.

11. A program product for controlling an intelligent three-phase power switch, the program product comprising:
a storage device; and
program code stored within the storage device that, when executed by a controller of the intelligent three-phase power switch, configures the controller to:
detect an overcurrent event that is cleared by a downstream protective device without a corresponding voltage change on an upstream portion of a power distribution circuit; and
responsive to detecting the overcurrent event, employ voltage restraint and refrain from opening the intelligent three-phase power switch, such that a coordinating downstream protective device can clear the overcurrent event by cycling.

12. The intelligent three-phase power switch of claim 11, wherein the program code, when executed by the controller, configures the controller to:
sense that a current on one or more phases of a downstream portion of the power distribution circuit has exceeded a threshold current and initiate counting of a number of times that an upstream protective device de-energizes the power distribution circuit;
responsive to the count satisfying a predetermined threshold count, and while the power distribution circuit is de-energized, open the intelligent three-phase power switch to isolate the downstream portion of the power distribution system without the upstream protective device locking out all of the power distribution circuit.

13. A program product for controlling an intelligent three-phase power switch, the program product comprising:
a storage device; and
program code stored within the storage device that, when executed by a controller of the intelligent three-phase power switch, configures the controller to:
sense that a current on one or more phases of a downstream portion of a power distribution circuit has exceeded a threshold current and initiate counting of a number of times that an upstream protective device de-energizes the power distribution circuit;
responsive to a count satisfying a predetermined threshold count, and while the power distribution circuit is de-energized, open the intelligent three-phase power switch to isolate the downstream portion of the power distribution system without the upstream protective device locking out all of the power distribution circuit.

14. The program product of claim 13, wherein the program code, when executed by the controller, configures the controller to:
detect an overcurrent event that is cleared by a downstream protective device without a corresponding voltage change on an upstream portion of the power distribution circuit; and
responsive to detecting the overcurrent event, employ voltage restraint and refrain from opening the intelligent three-phase power switch, such that a coordinating downstream protective device can clear the overcurrent event by cycling.
